(19) United States
(12) Patent Application Publication
(10) Pub. No.: US 2026/0300333 A1
(43) Pub. Date: Oct. 1, 2026

(54) INFORMATION PROCESSING DEVICE, INFORMATION PROCESSING METHOD, AND NON-TRANSITORY COMPUTER READABLE MEDIUM

(71) Applicant: NEC Corporation, Tokyo (JP)

(72) Inventors: Ryosuke HOTCHI, Tokyo (JP); Masaharu MORIMOTO, Tokyo (JP); Masaki INOKUCHI, Tokyo (JP); Shunsuke OSAKI, Tokyo (JP); Tatsuya FUKUDA, Tokyo (JP); Yoshiaki SAKAE, Tokyo (JP); Joe BRINTON, Tokyo (JP); Sian En OOI, Tokyo (JP)

(73) Assignee: NEC Corporation, Tokyo (JP)

(21) Appl. No.: 19/440,968

(22) Filed: Jan. 6, 2026

(30) Foreign Application Priority Data
Mar. 26, 2025 (JP) 2025-052243

(51) Int. Cl. G06F 16/3329; G06F 16/334

(52) U.S. Cl. CPC G06F 16/3329; G06F 16/334

(57) ABSTRACT

An information processing device includes a reception unit for receiving an input of target data as input data to a generation model, an extraction unit for extracting an input/output example associated with the target data, and a generation control unit for causing the generation model to refer to the input/output example extracted by the extraction unit and generate output data associated with the input/output example and the target data. The generated output data can also be used for user’s decision making.

This application is based upon and claims the benefit of priority from Japanese patent application No. 2025-052243, filed on Mar. 26, 2025, the disclosure of which is incorporated herein in its entirety by reference.

### TECHNICAL FIELD

The present disclosure relates to an information processing device, an information processing method, and an information processing program.

### BACKGROUND ART

A technique for performing natural language processing such as questions and answers using a Large Language Model (LLM) is known. A related art related to LLM includes, for example, that described in JP 7441366 B2 below. JP 7441366 B2 describes an information processing device that selects a database associated with an input question among a plurality of databases storing different types of data based on the content of the question, generates a prompt for inputting into a language model based on the selected database and the question, and generates an answer based on the generated prompt and the language model. Since the information processing device described in JP 7441366 B2 generates an answer based on a database selected based on the content of the question, it is possible to generate an answer with improved accuracy.

### SUMMARY

However, the information processing device described in JP 7441366 B2 can only reflect the data recorded in the database in the answer, and cannot adjust the criterion for generating the answer, and thus there is room for further improvement in terms of enhancing the accuracy of the answer. For example, it is assumed that a question “Does the content of sentence XXX satisfy the condition of YYY?” is input to the LLM. In this case, if the LLM determination criterion as to whether the above condition is satisfied is deviated from the sense of the interrogator, it is considered that there is a high possibility that an answer that the interrogator feels uncomfortable is generated even if the LLM is caused to refer to the data recorded in the database.

In addition, the fact that there is room for improvement in terms of higher accuracy is not limited to the case of causing the LLM to generate an answer to a question, and is common to the case of causing any generation model to generate any output data. An example object of the present disclosure is to provide a technique capable of improving accuracy of output data generated by a generation model.

An information processing device according to an example aspect of the present disclosure includes a reception means for receiving an input of target data as input data for a generation model subjected to machine learning to generate output data associated with input data, an extraction means for extracting an input/output example associated with the target data from a plurality of input/output examples including a combination of input data and output data, and a generation control means for causing the generation model to refer to the input/output example extracted by the extraction means and generate output data associated with the input/output example and the target data.

In an information processing method according to an example aspect of the present disclosure, at least one processor executes reception processing of receiving an input of target data as input data for a generation model subjected to machine learning to generate output data associated with input data, extraction processing of extracting an input/output example associated with the target data from a plurality of input/output examples including a combination of input data and output data, and generation control processing of causing the generation model to refer to the input/output example extracted in the extraction processing and generate output data associated with the input/output example and the target data.

An information processing program according to an example aspect of the present disclosure causes a computer to function as a reception means for receiving an input of target data as input data for a generation model subjected to machine learning to generate output data associated with input data, an extraction means for extracting an input/output example associated with the target data from a plurality of input/output examples including a combination of input data and output data, and a generation control means for causing the generation model to refer to the input/output example extracted by the extraction means and generate output data associated with the input/output example and the target data.

According to an example aspect of the present disclosure, there is an example effect that the accuracy of the output data generated by the generation model can be improved.

### BRIEF DESCRIPTION OF THE DRAWINGS

FIG. 1 is a block diagram illustrating a configuration of an information processing device according to the present disclosure;

FIG. 2 is a flowchart illustrating a flow of an information processing method according to the present disclosure;

FIG. 3 is a block diagram illustrating a configuration of another information processing device according to the present disclosure;

FIG. 4 is a diagram illustrating an execution example of a determination task by the information processing device illustrated in FIG. 3;

FIG. 5 is a diagram illustrating a display screen example displayed at the time of execution of the determination task by the information processing device illustrated in FIG. 3;

FIG. 6 is a flowchart illustrating a flow of processing executed by the information processing device illustrated in FIG. 3; and

FIG. 7 is a block diagram illustrating a configuration of a computer that functions as the information processing device according to the present disclosure.

### EXAMPLE EMBODIMENT

Hereinafter, example embodiments of the present invention will be exemplified. However, the present invention is not limited to the following exemplary example embodiments, and various modifications can be made within a scope described in the claims. For example, example embodiments obtained by appropriately combining techniques (some or all of things or methods) adopted in the following exemplary example embodiments can also be included in the scope of the present invention. Example embodiments obtained by appropriately omitting some of the techniques adopted in the following exemplary example embodiments can also be included in the scope of the present invention. Effects mentioned in the following exemplary example embodiments are examples of effects expected in the exemplary example embodiments, and do not define extension of the present invention. That is, example embodiments that do not provide the effects mentioned in each of the exemplary example embodiments described below can also be included in the scope of the present invention.

### First Exemplary Example Embodiment

A first exemplary example embodiment that is an example of the example embodiments of the present invention will be described in detail with reference to the drawings. The present exemplary example embodiment is a basic form of each exemplary example embodiment to be described below. An application range of each technique adopted in the present exemplary example embodiment is not limited to the present exemplary example embodiment. That is, each technique adopted in the present exemplary example embodiment can also be adopted in another exemplary example embodiment included in the present disclosure within a range in which no particular technical problem occurs. Each technology illustrated in the drawings referred to for describing the present exemplary example embodiment can also be adopted in another exemplary example embodiment included in the present disclosure within a range in which no particular technical problem occurs.

### Configuration of Information Processing Device 1

A configuration of an information processing device 1 according to the present exemplary example embodiment will be described with reference to FIG. 1. FIG. 1 is a block diagram illustrating the configuration of the information processing device 1. As illustrated in FIG. 1, the information processing device 1 includes a reception unit 101, an extraction unit 102, and a generation control unit 103.

The reception unit 101 receives an input of target data as input data for a generation model subjected to machine learning to generate output data associated with the input data. Here, the “input data” means data input to cause the generation model to generate output data, and is data from which the output data is generated.

The reception unit 101 receives target data in a format associated with the generation model. For example, in a case where a generation model to which text data described in a natural language can be input is used, the reception unit 101 receives an input of target data in a text format described in a natural language. Furthermore, for example, in a case where a generation model to which image data can be input, such as a generation model that generates text data describing the content of the input image is used, the reception unit 101 may receive the input of the image data.

The “generation model” is a learned model subjected to machine learning to output output data associated with input data. The above generation model can also be referred to as generative Artificial Intelligence (AI) or the like. The output data generated by the above generation model is any data. For example, the generation model may generate at least one of text data, image data (may be still image data or moving image data), and voice data.

The extraction unit 102 extracts an input/output example associated with the target data received by the reception unit 101 from a plurality of input/output examples including a combination of input data and output data. This input/output example may include input data and output data actually input to the above generation model, or may include input data and output data input to another generation model. In addition, this input/output example may be obtained by modifying a part of the input data and the output data actually input to the above generation model or another generation model, or may be artificially generated.

The generation control unit 103 causes the generation model to refer to the input/output example extracted by the extraction unit 102 and generate output data according to the input/output example and the target data. Here, causing the generation model to refer to the input/output example means inputting the input/output example to the generation model in some form. Although details will be described in the second exemplary example embodiment, for example, the generation control unit 103 may cause the generation model to refer to the input/output example by inputting a prompt including the input/output example and the target data to the generation model. The prompt indicates an instruction for the generation model. By inputting a prompt to the generation model, output data associated with an instruction indicated in the prompt is output from the generation model.

As described above, the information processing device 1 according to the present exemplary example embodiment adopts a configuration including the reception unit 101 for receiving an input of target data as input data for a generation model subjected to machine learning to generate output data associated with the input data, the extraction unit 102 for extracting an input/output example associated with the target data received by the reception unit 101 from among a plurality of input/output examples including a combination of the input data and the output data, and the generation control unit 103 for causing the generation model to refer to the input/output example extracted by the extraction unit 102 and generate output data associated with the input/output example and the target data.

According to the above configuration, the input/output example associated with the target data is extracted, and the generation model is caused to refer to the extracted input/output example to generate the output data. As a result, the criterion when the output data is generated in the input/output example can be reflected in the generation of the output data for the target data. Therefore, according to the information processing device 1, an effect is obtained that the accuracy of the output data generated by the generation model can be improved.

Furthermore, the output data generated by the information processing device 1 can also be used for decision making by the user of the information processing device 1. For example, the user inputs, to the information processing device 1, target data indicating a matter for which the user is to make a final decision, thereby generating a decision result regarding the matter. Then, the user can make a final decision with reference to the decision result.

### Information Processing Program

The functions of the information processing device 1 described above can also be achieved by a program. An information processing program according to the present exemplary example embodiment causes a computer to function as a reception means for receiving an input of target data as input data for a generation model subjected to machine learning to generate output data associated with input data, an extraction means for extracting an input/output example associated with the target data from among a plurality of input/output examples including a combination of the input data and the output data, and a generation control means for causing the generation model to refer to the input/output example extracted by the extraction means and generate output data associated with the input/output example and the target data. According to this information processing program, an effect is obtained that the accuracy of the output data generated by the generation model can be improved.

### Flow of Information Processing Method

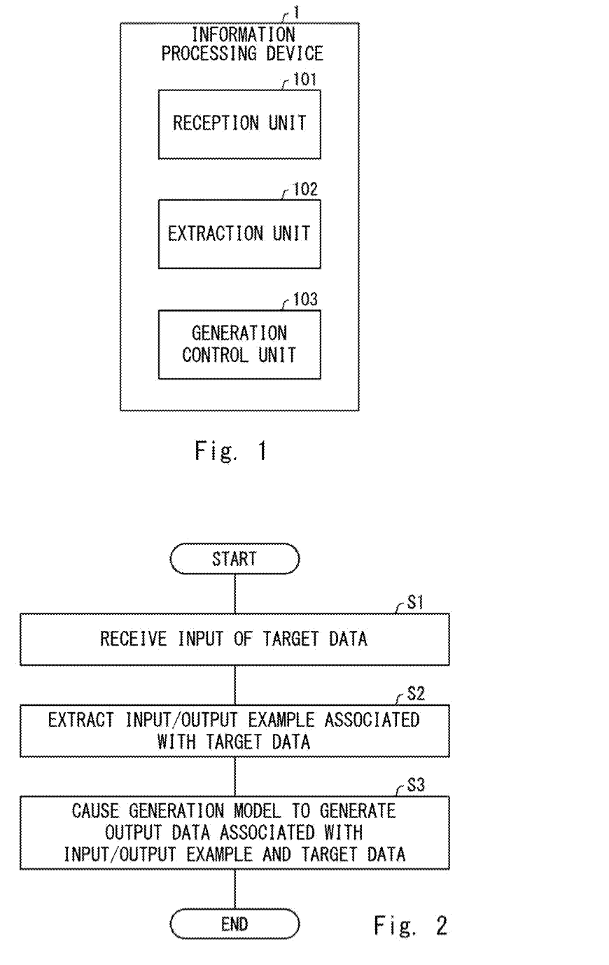

Next, a flow of an information processing method according to the present exemplary example embodiment will be described with reference to FIG. 2. FIG. 2 is a flowchart illustrating a flow of an information processing method. An executing entity of each step in this information processing method may be a processor included in the information processing device 1, may be a processor included in another device, or an executing entity of each step may be a processor provided in each of different devices.

In S1 (reception processing), at least one processor receives an input of target data as input data for a generation model subjected to machine learning to generate output data associated with the input data.

In S2 (extraction processing), at least one processor extracts an input/output example associated with the target data received in S1 from a plurality of input/output examples including a combination of input data and output data.

In S3 (generation control processing), at least one processor causes the generation model to refer to the input/output example extracted in the extraction processing, and generate output data associated with the input/output example and the target data.

As described above, the information processing method according to the present exemplary example embodiment adopts a configuration in which at least one processor executes reception processing of receiving input of target data as input data to a generation model subjected to machine learning to generate output data associated with the input data, extraction processing of extracting an input/output example associated with the target data received in the reception processing from among a plurality of input/output examples including a combination of the input data and the output data, and generation control processing of causing the generation model to refer to the input/output example extracted in the extraction processing and generate output data associated with the input/output example and the target data. According to this information processing method, an effect is obtained that the accuracy of the output data generated by the generation model can be improved.

### Second Exemplary Example Embodiment

A second exemplary example embodiment that is an example of the example embodiments of the present invention will be described in detail with reference to the drawings. Components having the same functions as the components described in the above-described exemplary example embodiment are denoted by the same reference signs, and the description thereof will be appropriately omitted. An application range of each technique adopted in the present exemplary example embodiment is not limited to the present exemplary example embodiment. That is, each technique adopted in the present exemplary example embodiment can also be adopted in another exemplary example embodiment included in the present disclosure within a range in which no particular technical problem occurs. Furthermore, each technique illustrated in the drawings referred to for describing the present exemplary example embodiment may also be adopted in another exemplary example embodiment included in the present disclosure within a scope in which no particular technical problem arises.

### Configuration of Information Processing Device 1A

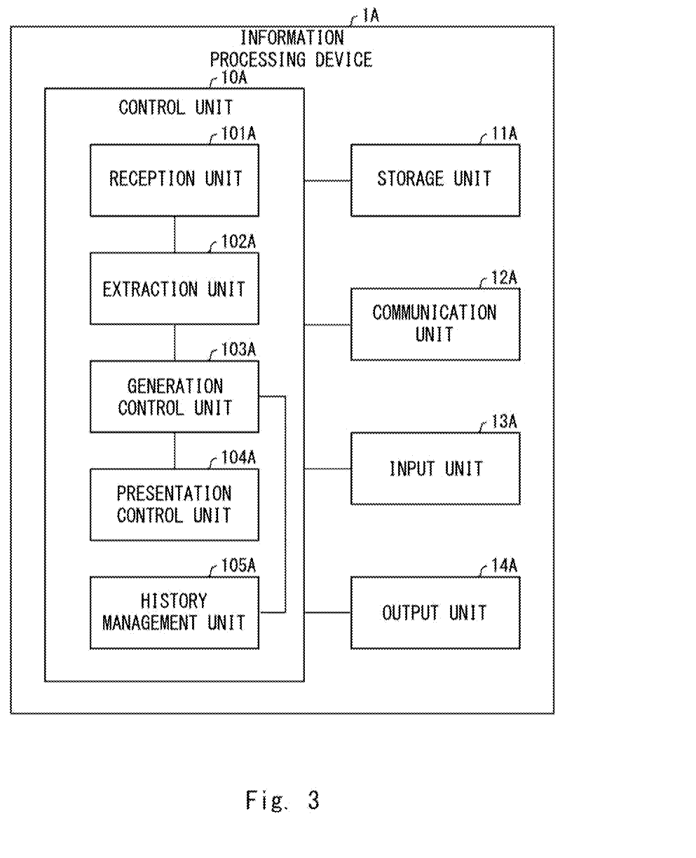

A configuration of an information processing device 1A according to the present exemplary example embodiment will be described with reference to FIG. 3. FIG. 3 is a block diagram illustrating a configuration of the information processing device 1A. The information processing device 1A is a device having a function of receiving input of target data by a user, causing a generation model to generate output data associated with the target data, and providing the generated output data to the user. The information processing device 1A may be a local device used by individual users, or may be a server that provides generation service of output data to a plurality of users.

As illustrated, the information processing device 1A includes a control unit 10A for integrally controlling each unit of the information processing device 1A, and a storage unit 11A for storing various types of data to be used by the information processing device 1A. The information processing device 1A includes a communication unit 12A for the information processing device 1A to communicate with another device, an input unit 13A for accepting an input to the information processing device 1A, and an output unit 14A for the information processing device 1A to output data. Then, the control unit 10A includes a reception unit 101A, an extraction unit 102A, a generation control unit 103A, a presentation control unit 104A, and a history management unit 105A.

Similarly to the reception unit 101 of the first exemplary example embodiment, the reception unit 101A receives an input of target data as input data for a generation model subjected to machine learning to generate output data associated with the input data. Hereinafter, an example in which a language model capable of performing natural language processing is used as the generation model will be described, and this language model will be referred to as a generation model 2A.

The language model capable of performing natural language processing can be generated by learning the arrangement of constituent elements (words etc.) in a sentence of a natural language and the arrangement of a sentence and a sentence in a writing. Examples of the language model capable of performing natural language processing include, for example, Bidirectional Encoder Representations from Transformers (BERT), Robustly optimized BERT approach (RoBERTa), Efficiently Learning an Encoder that Classifies Token Replacements Accurately (ELECTRA), and the like.

In the following, it is assumed that the target data is text data indicating the target content of sentence and the determination condition in the determination task of determining whether the target content of sentence satisfies the determination condition. In this case, by inputting the target data to the generation model 2A, an execution result of the determination task, that is, output data indicating whether the target content of sentence satisfies the determination condition is generated and output by the generation model 2A. The task to be executed by the generation model 2A is not limited to the determination task. For example, it is also possible to cause the generation model 2A to execute a task of generating an answer to a question, a classification task of classifying a designated target, an analysis task of analyzing the designated target, a prediction task of predicting the designated target, and the like.

The target content of sentence is a target for determination on the satisfiability of the determination condition. For example, it is assumed that it is desired to determine whether a product conforms to a predetermined standard from a specification of the product. In this case, a content of sentence indicating a requirement of a standard may be input to the information processing device 1A as the “determination condition”, and a content of sentence relating to the standard of the product in the specification of the product or the like may be input as the “target content of sentence”. As a result, it is possible to cause the information processing device 1A to generate a determination result as to whether the product conforms to the standard.

Furthermore, for example, a content of sentence describing a symptom of a certain disease may be referred to as the “determination condition”, and an explanatory sentence explaining the symptom of a subject who may be suffering from the disease may be referred to as the “target content of sentence”. In this case, it is possible to cause the information processing device 1A to generate a determination result as to whether the subject is suffering from the above-described disease. As described above, the information processing device 1A can also be used for healthcare application. The determination target is not limited to a content of sentence, that is, content in a text format, and may be content in a format other than text (e.g., image etc.).

Similarly to the extraction unit 102 of the first exemplary example embodiment, the extraction unit 102A extracts an input/output example associated with the target data received by the reception unit 101A from a plurality of input/output examples including a combination of input data and output data. Specifically, the extraction unit 102A extracts a determination example associated with the determination condition and the target content of sentence received by the reception unit 101A from among a plurality of determination examples including a combination of the target content of the sentence to be determined in the determination task, the determination condition of the determination task, and the determination result of the determination task. Details of the extraction method will be described later.

Similarly to the generation control unit 103 of the first exemplary example embodiment, the generation control unit 103A causes the generation model 2A to refer to the input/output example extracted by the extraction unit 102A and generate output data associated with the input/output example and the target data. Specifically, the generation control unit 103A causes the generation model 2A to refer to the determination example extracted by the extraction unit 102A and generate a determination result associated with the determination example, and the determination condition and the target content of sentence received by the reception unit 101A. This determination result is the execution result of the determination task, that is, the determination result regarding the satisfiability of the determination condition of the target content of sentence.

The presentation control unit 104A performs processing of presenting various types of information to the user. For example, the presentation control unit 104A may present the determination condition and the target content of sentence received by the reception unit 101A to the user who has input them. Furthermore, the presentation control unit 104A may present output data associated with the determination condition and the target content of sentence, that is, the determination result generated by the generation model 2A to the user.

A mode of presentation of the information by the presentation control unit 104A is any mode. For example, the presentation control unit 104A may present information to the user by causing a display device to display and output the information, or may present information to the user by causing a voice output device to output the information by voice. Hereinafter, an example in which the presentation control unit 104A causes the display device to display and output information will be described. The device for outputting information may be a device included in the information processing device 1A (e.g., the output unit 14A) or a device external to the information processing device 1A (e.g., a terminal device or the like possessed by the user).

The history management unit 105A manages an input/output history of the generation model 2A. For example, the history management unit 105A records a set of the determination condition and the target content of sentence received by the reception unit 101A and the determination result generated by the generation model 2A as an input/output history. A recording destination of the input/output history is optional. For example, the history management unit 105A may record the input/output history in the storage unit 11A, or may record the input/output history in a database (e.g., a database 3A to be described later) or the like external to the information processing device 1A.

As described above, similarly to the information processing device 1 of the first exemplary example embodiment, the information processing device 1A includes the reception unit 101A for receiving an input of a determination condition and a target content of sentence (target data) of a determination task as input data to the generation model 2A subjected to machine learning to generate output data associated with the input data, the extraction unit 102A for extracting a determination example associated with the determination condition and the target content of sentence received by the reception unit 101A from among a plurality of determination examples (input/output examples), and the generation control unit 103 for causing the generation model 2A to refer to the determination example extracted by the extraction unit 102A and generate a determination result (output data) associated with the determination example, the determination condition, and the target content of sentence. Therefore, an effect is obtained that the accuracy of determination by the generation model 2A can be improved.

Furthermore, as described above, the information processing device 1A includes the presentation control unit 104A for presenting the determination result (output data of the generation model 2A) generated by the generation model 2A. As a result, in addition to the effect obtained by the information processing device 1, an effect is obtained that the user or the like of the information processing device 1A can recognize the determination result generated by the generation model 2A.

The target data in the present exemplary example embodiment is not limited to the determination condition and the target content of sentence in the determination task. Furthermore, the target of extraction by the extraction unit 102A is not limited to the determination example. That is, the “determination condition and target content of sentence (in the determination task)”, the “determination condition”, and the “target content of sentence” in the present exemplary example embodiment can be read as any “target data”. In addition, the “determination example” in the present exemplary example embodiment can be read as any “input/output example”.

### Execution Example of Determination Task

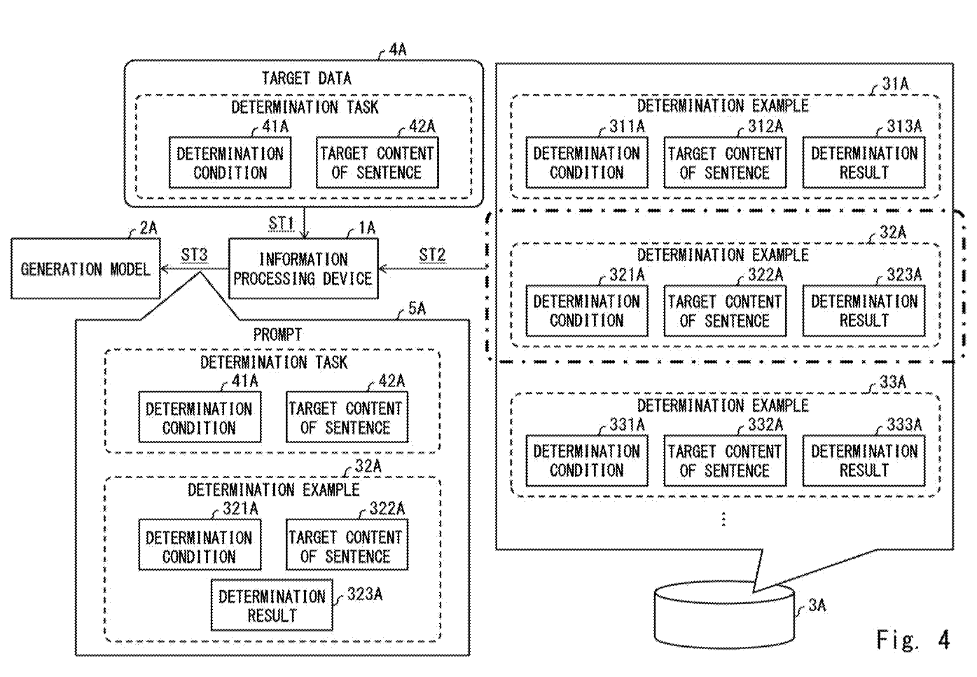

FIG. 4 is a diagram illustrating an execution example of a determination task by the information processing device 1A. In ST1 of FIG. 4, a determination condition 41A and a target content of sentence 42A in the determination task are input to the information processing device 1A. That is, the determination task in the example of FIG. 4 is a task of determining whether the target content of sentence 42A satisfies the determination condition 41A. The input determination condition 41A and target content of sentence 42A are acquired by the reception unit 101A.

In ST2, a determination example associated with the determination condition 41A and the target content of sentence 42A is extracted from a plurality of determination examples such as the determination examples 31A, 32A, and 33A recorded in the database 3A. Specifically, in the example of FIG. 4, the determination example 32A is extracted. The extraction of the determination example 32A is performed by the extraction unit 102A.

In this manner, the extraction unit 102A may extract a determination example associated with the determination condition 41A and the target content of sentence 42A (target data) from the database 3A recording the determination example (input/output example including a combination of input data and output data). As a result, in addition to the effect obtained by the information processing device 1, an effect is obtained that similar criterion as the determination example (input/output example) recorded in the database 3A can be applied to the determination (generation of output data) by the generation model 2A.

The determination example recorded in the database 3A may be a determination example by the generation model 2A, may be a determination example by another generation model, or may include both of them. In addition, the determination example recorded in the database 3A may include a determination example obtained by correcting the determination example by the generation model 2A or another generation model by a person, or may include a determination example by a person. However, it is preferable to unify the determination criteria of the determination examples recorded in the database 3A.

The determination example 32A illustrated in FIG. 4 includes a determination condition 321A and a target content of sentence 322A, and also includes a determination result 323A. That is, the determination example 32A illustrates a determination task of determining whether the target content of sentence 322A satisfies the determination condition 321A and a determination result 323A thereof. The determination result 323A may include a basis of the determination. Since the basis of the determination can also be said to indicate the determination criterion, it is possible to more accurately reflect the determination criterion of the determination example 32A in the determination task by causing the generation model 2A to refer to the determination result 323A including the basis of the determination. The determination examples 31A and 33A are similar to the determination example 32A, and thus the description of the determination examples 31A and 33A will be omitted.

The extraction unit 102A may extract a determination example using at least one of the determination condition 41A and the target content of sentence 42A. For example, the extraction unit 102A may extract a determination example to which the same or similar determination condition as the determination condition 41A is applied. As a result, in addition to the effect obtained by the information processing device 1, an effect is obtained that a highly valid determination criterion can be applied in the determination of the determination task. This is because, in a case where the same or similar determination conditions are applied, the possibility that the common determination criterion can be applied is high. The extraction unit 102A may extract a plurality of determination examples.

The determination example to which the same determination condition as the determination condition 41A is applied can be extracted by searching the database 3A for a determination example in which the same determination condition as the determination condition 41A is set. The method of extracting the determination example to which the determination condition similar to the determination condition 41A is applied is not particularly limited. For example, the extraction unit 102A may extract a keyword from the determination condition 41A and search the database 3A for a determination example in which a determination condition including the extracted keyword is set. In this case, the determination conditions including the common keyword are regarded as similar determination conditions. Furthermore, for example, the extraction unit 102A may calculate a feature quantity indicating the feature of the determination condition 41A, and calculate a similarity between the calculated feature quantity and the feature quantity of the determination condition in each determination example recorded in the database 3A. Then, the extraction unit 102A may extract a determination example in which the calculated similarity is equal to or greater than a predetermined threshold value, or a predetermined number of determination examples in which the calculated similarity is higher. The feature quantity can be calculated by a technique such as, for example, Word2Vec. Furthermore, the similarity of the feature quantities can be represented by, for example, cosine similarity or the like.

Furthermore, for example, the extraction unit 102A may extract a determination example in which determination targets of the satisfiability of the determination condition (target content of sentence in the example of FIG. 4) are the same or similar. As a result, in addition to the effect obtained by the information processing device 1, an effect is obtained that a highly valid determination example can be extracted. This is because, in a determination example in which determination targets are the same or similar, the possibility that applicable determination criteria are applied also in the determination task is high. As a method of extracting a determination example in which the target content of sentence is the same or similar, a method similar to the case of extracting a determination example to which a determination condition the same or similar to the determination condition 41A is applied can be applied.

In ST3, in addition to the determination condition 41A and the target content of sentence 42A, a prompt 5A including the determination example 32A extracted by the extraction unit 102A is input to the generation model 2A. The generation of the prompt 5A and the input to the generation model 2A are performed by the generation control unit 103A.

A method for generating the prompt 5A is not particularly limited. For example, the generation control unit 103A can generate the prompt 5A by incorporating the determination condition 41A, the target content of sentence 42A, and the determination example 32A in a predetermined template. The template may be, for example, “Please determine whether the [target content of sentence] to which the determination criterion in the [determination example] has been applied satisfies the [determination condition], and answer the determination result”. The prompt 5A can be generated by incorporating the determination condition 41A and the target content of sentence 42A and the determination example 32A (more specifically, the target content of sentence 322A and the determination condition 321A and the determination result 323A) in the portions of [determination condition], [target content of sentence], and [determination example] in this template.

Furthermore, for example, the generation control unit 103A may input the determination condition 41A, the target content of sentence 42A, and the determination example 32A to a model capable of natural language processing such as the generation model 2A, and may generate the prompt 5A for instructing to determine whether the target content of sentence 42A satisfies the determination condition 41A by applying the determination criterion in the determination example 32A.

Furthermore, for example, the generation control unit 103A may generate a prompt for instructing to output the basis of the determination result together with the determination result. By using such a prompt, it is possible to cause the generation model 2A to generate the determination result and the basis thereof. As described above, the basis for the determination is useful in clarifying the criterion for the determination.

As described above, the generation control unit 103A may cause the generation model 2A to refer to the determination example by inputting the determination example (input/output example) extracted by the extraction unit 102A to the generation model 2A together with the determination condition 41A and the target content of sentence 42A (target data). As a result, the determination example (input/output example) can be reflected in the determination result (output data) output by the generation model 2A.

Furthermore, the generation control unit 103A may cause the generation model 2A to refer to the determination example by inputting the determination example (input/output example) extracted by the extraction unit 102A to the generation model 2A as the input/output history of the generation model 2A. Even in a case where this configuration is adopted, the determination example can be reflected in the determination result (output data) output by the generation model 2A.

For example, the generation control unit 103A may generate an input/output history in which the target content of sentence 322A and the determination condition 321A in the determination example 32A extracted by the extraction unit 102A are assumed to be input by the user and the determination result 323A is assumed to be generated by the generation model 2A, and input the input/output history to the generation model 2A. As a result, on the premise that the target content of sentence 322A and the determination condition 321A are input and the determination result 323A is generated, the generation model 2A can be caused to generate the determination result for the determination task defined by the determination condition 41A and the target content of sentence 42A.

In the example of FIG. 4, the determination condition 41A, the target content of sentence 42A, and the determination example 32A (target content of sentence 322A, determination condition 321A, and determination result 323A) are included in one prompt 5A, but these pieces of information may be distributed to a plurality of prompts.

### Screen Example

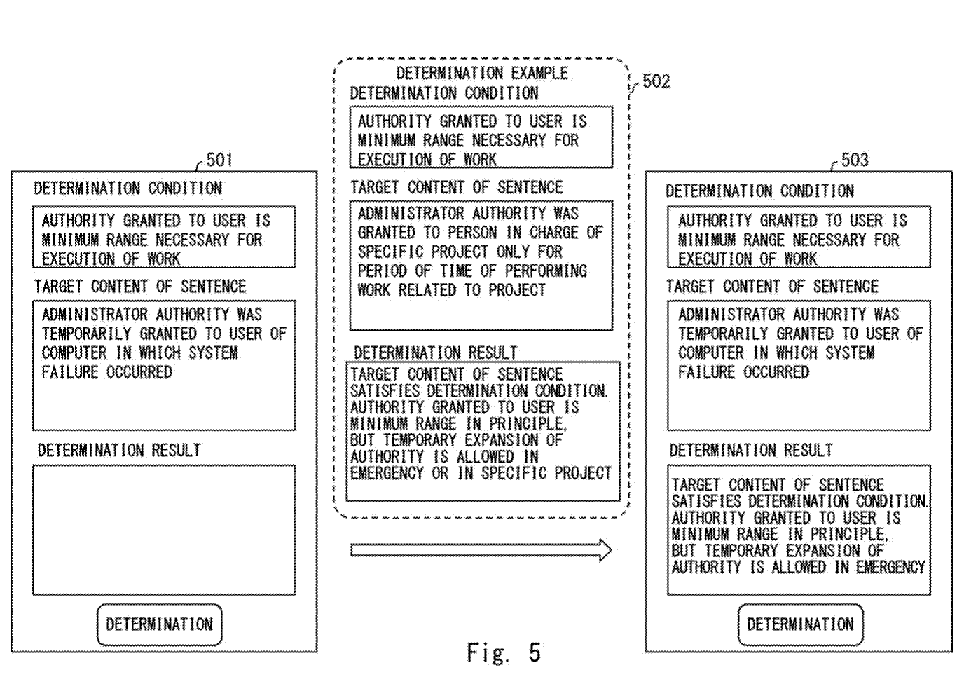

FIG. 5 is a diagram illustrating an example of a display screen displayed at the time of execution of the determination task by the information processing device 1A. More specifically, reference numeral 501 in FIG. 5 denotes a display screen example at the time point the determination condition and the target content of sentence are input, and reference numeral 503 denotes a display screen example that presents the determination result. Such a display screen is presented to the user by the presentation control unit 104A. Reference numeral 502 in FIG. 5 denotes a determination example referred to in generating the determination result. The determination example 502 does not need to be presented to the user.

The screen example 501 includes an input item for receiving input of a determination condition, an input item for receiving input of a target content of sentence, and an item for displaying a determination result. The reception unit 101A may receive the input of the determination condition and the target content of sentence via such a User Interface (UI) screen. In the example of FIG. 5, a check item related to cyber security is input as a determination condition, and a content of sentence describing an action to be checked from the viewpoint of cyber security is input as a target content of sentence.

In a case where a “determination” button (software key) in the screen example 501 is operated, extraction of a determination example is started. In the example of FIG. 5, the determination condition of the determination example 502 extracted by the extraction unit 102A is the same as the determination condition of the determination task illustrated in the screen example 501. In addition, it can be said that the target content of sentence of the determination example 502 and the target content of sentence of the determination task shown in the screen example 501 are similar in that both are descriptions about an action of granting administrator authority. Therefore, the extraction unit 102A can extract the determination example 502 from the database 3A, for example, based on the similarity of the determination condition and the target content of sentence.

In a case where the determination example 502 is extracted, the generation control unit 103A causes the generation model 2A to refer to the determination example 502 and execute the determination task. Then, the presentation control unit 104A presents the determination result to the user. Specifically, the presentation control unit 104A causes the determination result output by the generation model 2A to be displayed in the item for displaying the determination result in the screen example 501. As a result, the screen example 501 presented to the user is updated to the screen example 503.

The determination result shown in the screen example 503 reflects the determination criterion in the determination example 502. That is, the determination criterion in the determination example 502 is that the authority granted to the user is a minimum range in principle, but temporary expansion of the authority is allowed in an emergency or in a specific project. In the example of FIG. 5, by applying this determination criterion, a determination result indicating that the determination condition is satisfied is obtained for an action that can be determined not to satisfy the determination condition that the administrator authority is temporarily granted to the user of the computer in which the system failure has occurred.

### Flow of Processing: Recording of Non-Reference Pair or Non-Reference Candidate Pair

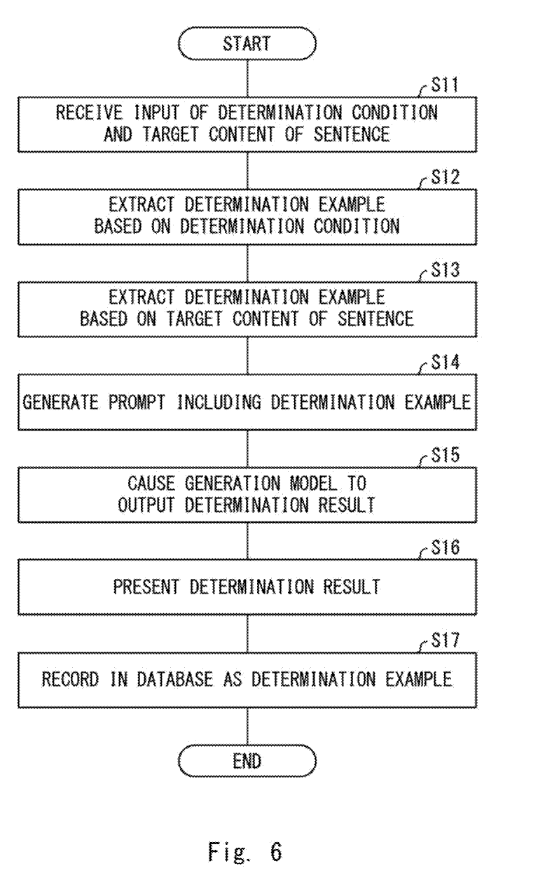

A flow of processing executed by the information processing device 1A will be described with reference to FIG. 6. FIG. 6 is a flowchart illustrating a flow of processing executed by the information processing device 1A. The flowchart of FIG. 6 includes each processing of the information processing method of the present exemplary example embodiment.

In S11 (reception processing), the reception unit 101A receives the input of the target data as the input data for the generation model 2A subjected to machine learning to generate the output data associated with the input data. Specifically, the reception unit 101A receives the determination condition and the target content of sentence in the determination task as the target data.

In S12 (extraction processing), the extraction unit 102A extracts a determination example associated with the determination condition received in S11 from a plurality of determination examples including combinations of the determination condition, the target content of sentence, and the determination result. For example, the extraction unit 102A may extract a determination example to which a determination condition same as or similar to the determination condition received in S11 is applied from the database 3A illustrated in FIG. 4. In the example of FIG. 6, the determination example is extracted in two stages, and S12 is the first stage. Therefore, in S12, it is preferable to extract a determination example with the extraction condition such that the plurality of determination examples are extracted.

In S13 (extraction processing), the extraction unit 102A extracts a determination example associated with the target content of sentence received in S11 from the determination examples extracted in S12. For example, the extraction unit 102A may calculate similarity between the target content of sentence of each determination example extracted in S12 and the target content of sentence received in S11. Then, the extraction unit 102A may specify a predetermined number of target content of sentences having a higher degree of similarity with the target content of sentence received in S11, and extract a determination example including the target content of sentences.

The extraction unit 102A may perform the processing of S12 before S11. In addition, it is not always necessary to perform both the processing of S11 and S12, and only one of them may be performed.

In S14, the generation control unit 103A generates a prompt including the determination example extracted in S13. More specifically, the generation control unit 103A generates a prompt for instructing to determine whether the target content of sentence satisfies the determination condition by including the determination example extracted in S13 and the determination condition and the target content of sentence received in S11 and applying the determination criterion in the determination example.

In S15 (generation control processing), the generation control unit 103A causes the generation model 2A to refer to the determination example extracted in S13, and generate output data, that is, a determination result of the determination task associated with the determination example and the determination condition and the target content of sentence received in S11. Specifically, the generation control unit 103A inputs the prompt generated in S14 to the generation model 2A and causes the generation model to output the determination result.

In S16, the presentation control unit 104A presents the determination result in S15 to the user. In addition, in S17, the history management unit 105A associates the determination result in S15 with the determination condition and the target content of sentence received in S11, and records them in the database 3A as a new determination example. Accordingly, the processing of FIG. 6 ends.

In S17, a condition may be provided in the determination example to be recorded in the database 3A. For example, the history management unit 105A may record, in the database 3A, a determination example that satisfies at least either condition of the user giving a positive feedback on the determination result presented in S16, or the user not giving a negative feedback on the determination result presented in S16. As a result, a case determined to be valid by the user or a case determined not to be invalid by the user can be recorded as a determination example. Then, it becomes possible to increase the possibility of generating a determination result complying with the intention of the user by causing the generation model 2A to refer to such a determination example.

Furthermore, the reception unit 101A may receive correction of the user on the determination result presented in S16. In this case, the history management unit 105A records the corrected determination result in the database 3A in association with the determination condition and the target content of sentence received in S11. In this case as well, it becomes possible to increase the possibility of generating a determination result complying with the intention of the user.

### Modified Examples

An executing entity of each processing described in the above-described exemplary example embodiments is optional, and is not limited to the above-described examples. For example, a system having functions similar to those of the information processing devices 1 and 1A can be constructed by a plurality of devices capable of communicating with each other. The executing entity of each processing illustrated in the flowchart of FIG. 6 may be one device (may be rephrased as a processor) or a plurality of devices (may be similarly rephrased as processors).

### Example of Implementation by Software

Some or all of the functions of the information processing devices 1 and 1A (hereinafter, also referred to as “each of the above devices”) may be implemented by hardware such as an integrated circuit (IC chip) or may be implemented by software.

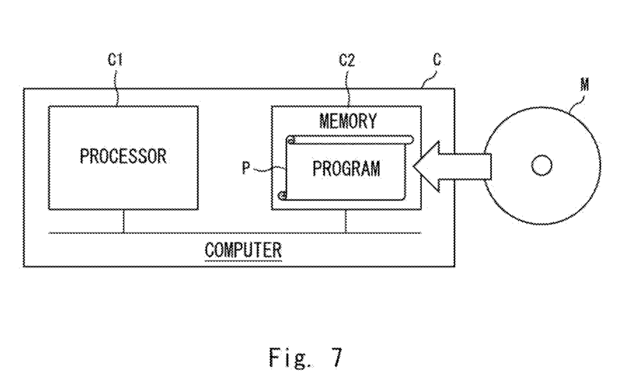

In the latter case, each of the above devices is implemented by, for example, a computer that executes a command of a program as software for implementing each function. An example of such a computer (hereinafter, referred to as a computer C) is illustrated in FIG. 7. FIG. 7 is a block diagram illustrating a hardware configuration of the computer C functioning as each of the above devices.

The computer C includes at least one processor C1 and at least one memory C2. A program (information processing program) P for operating the computer C as each of the above devices is recorded in the memory C2. In the computer C, the processor C1 reads the program P from the memory C2 and executes it, thereby implementing the functions of each of the above devices.

Examples of the processor C1 include, for example, a Central Processing Unit (CPU), a Graphic Processing Unit (GPU), a Digital Signal Processor (DSP), a Micro Processing Unit (MPU), a Floating point number Processing Unit (FPU), a Physics Processing Unit (PPU), a Tensor Processing Unit (TPU), a quantum processor, a microcontroller, and a combination thereof. As the memory C2, for example, a flash memory, a Hard Disk Drive (HDD), a Solid State Drive (SSD), or a combination of these can be used.

The computer C may further include a Random Access Memory (RAM) for loading the program P at the time of execution and temporarily storing various types of data. The computer C may further include a communication interface for transmitting and receiving data to and from another device. The computer C may further include an input/output interface for connecting input/output devices such as a keyboard, a mouse, a display, and a printer.

The program P can be recorded in a non-transitory tangible recording medium M readable by the computer C. As such a recording medium M, it is possible to use, for example, a tape, a disk, a card, a semiconductor memory, a programmable logic circuit, or the like. The computer C can acquire the program P via such a recording medium M. The program P can be transmitted via a transmission medium. As such a transmission medium, it is possible to use, for example, a communication network, a broadcast wave, or the like. The computer C can also acquire the program P via such a transmission medium.

Each of the above functions of each of the above devices may be achieved by a single processor provided in a single computer, may be achieved in cooperation with a plurality of processors provided in a single computer, or may be achieved in cooperation with a plurality of processors provided in a plurality of computers. The program causing each of the above devices to implement each of the above functions may be stored in a single memory provided in a single computer, may be stored in a distributed manner in a plurality of memories provided in a single computer, or may be stored in a distributed manner in a plurality of memories provided in a plurality of computers.

### Supplementary Information

The present disclosure includes the techniques described in the following supplementary notes. However, the present invention is not limited to the techniques described in the following supplementary notes, and various modifications can be made within the scope described in the claims.

### Supplementary Information A

The present disclosure includes the techniques described in the following supplementary notes. However, the present invention is not limited to the techniques described in the following supplementary notes, and various modifications can be made within the scope described in the claims.

### Supplementary Note A1

An information processing device including
a reception means for receiving an input of target data as input data for a generation model subjected to machine learning to generate output data associated with input data,
an extraction means for extracting an input/output example associated with the target data from a plurality of input/output examples including a combination of input data and output data, and
a generation control means for causing the generation model to refer to the input/output example extracted by the extraction means and generate output data associated with the input/output example and the target data.

### Supplementary Note A2

The information processing device according to supplementary note A1, in which the extraction means extracts an input/output example associated with the target data from a database in which input/output examples are recorded.

### Supplementary Note A3

The information processing device according to supplementary note A1 or A2, further including a presentation control means for presenting output data generated by the generation model.

### Supplementary Note A4

The information processing device according to any one of supplementary notes A1 to A3, in which
the target data includes information indicating a determination condition in a determination task for determining whether a determination target satisfies the determination condition, and
the extraction means extracts, as the input/output example, a determination example to which a determination condition same as or similar to the determination task is applied.

### Supplementary Note A5

The information processing device according to any one of supplementary notes A1 to A4, in which
the target data includes information indicating a determination target in a determination task for determining whether the determination target satisfies a determination condition, and
the extraction means extracts, as the input/output example, a determination example in which satisfaction of a determination condition is determined for a determination target same as or similar to the determination target.

### Supplementary Note A6

The information processing device according to any one of supplementary notes A1 to A5, in which the generation control means inputs the input/output example extracted by the extraction means to the generation model together with the target data to cause the generation model to refer to the input/output example.

### Supplementary Note A7

The information processing device according to any one of supplementary notes A1 to A5, in which the generation control means inputs the input/output example extracted by the extraction means to the generation model as an input/output history of the generation model to cause the generation model to refer to the input/output example.

### Supplementary Information B

The present disclosure includes the techniques described in the following supplementary notes. However, the present invention is not limited to the techniques described in the following supplementary notes, and various modifications can be made within the scope described in the claims.

### Supplementary Note B1

An information processing method in which at least one processor executes,
reception processing of receiving an input of target data as input data for a generation model subjected to machine learning to generate output data associated with input data,
extraction processing of extracting an input/output example associated with the target data from a plurality of input/output examples including a combination of input data and output data, and
generation control processing of causing the generation model to refer to the input/output example extracted in the extraction processing and generate output data associated with the input/output example and the target data.

### Supplementary Note B2

The information processing method according to supplementary note B1, in which in the extraction processing, the at least one processor extracts an input/output example associated with the target data from a database in which input/output examples are recorded.

### Supplementary Note B3

The information processing method according to supplementary note B1 or B2, in which the at least one processor includes presentation control processing of presenting output data generated by the generation model.

### Supplementary Note B4

The information processing method according to any one of supplementary notes B1 to B3, in which
the target data includes information indicating a determination condition in a determination task for determining whether a determination target satisfies the determination condition, and
in the extraction processing, the at least one processor extracts, as the input/output example, a determination example to which a determination condition same as or similar to the determination task is applied.

### Supplementary Note B5

The information processing method according to any one of supplementary notes B1 to B4, in which
the target data includes information indicating a determination target in a determination task for determining whether the determination target satisfies a determination condition, and
in the extraction processing, the at least one processor extracts, as the input/output example, a determination example in which satisfaction of a determination condition is determined for a determination target same as or similar to the determination target.

### Supplementary Note B6

The information processing method according to any one of supplementary notes B1 to B5, in which in the generation control processing, the at least one processor inputs the input/output example extracted in the extraction processing to the generation model together with the target data to cause the generation model to refer to the input/output example.

### Supplementary Note B7

The information processing method according to any one of supplementary notes B1 to B5, in which in the generation control processing, the at least one processor inputs the input/output example extracted in the extraction processing to the generation model as an input/output history of the generation model to cause the generation model to refer to the input/output example.

### Supplementary Information C

The present disclosure includes the techniques described in the following supplementary notes. However, the present invention is not limited to the techniques described in the following supplementary notes, and various modifications can be made within the scope described in the claims.

### Supplementary Note C1

An information processing program for causing a computer to function as,
a reception means for receiving an input of target data as input data for a generation model subjected to machine learning to generate output data associated with input data,
an extraction means for extracting an input/output example associated with the target data from a plurality of input/output examples including a combination of input data and output data, and
a generation control means for causing the generation model to refer to the input/output example extracted by the extraction means and generate output data associated with the input/output example and the target data.

### Supplementary Note C2

The information processing program according to supplementary note C1, in which the extraction means extracts an input/output example associated with the target data from a database in which input/output examples are recorded.

### Supplementary Note C3

The information processing program according to supplementary note C1 or C2, further causing the computer to function as a presentation control means for presenting output data generated by the generation model.

### Supplementary Note C4

The information processing program according to any one of supplementary notes C1 to C3, in which
the target data includes information indicating a determination condition in a determination task for determining whether a determination target satisfies the determination condition, and
the extraction means extracts, as the input/output example, a determination example to which a determination condition same as or similar to the determination task is applied.

### Supplementary Note C5

The information processing program according to any one of supplementary notes C1 to C4, in which
the target data includes information indicating a determination target in a determination task for determining whether the determination target satisfies a determination condition, and
the extraction means extracts, as the input/output example, a determination example in which satisfaction of a determination condition is determined for a determination target same as or similar to the determination target.

### Supplementary Note C6

The information processing program according to any one of supplementary notes C1 to C5, in which the generation control means inputs the input/output example extracted by the extraction means to the generation model together with the target data to cause the generation model to refer to the input/output example.

### Supplementary Note C7

The information processing program according to any one of supplementary notes C1 to C5, in which the generation control means inputs the input/output example extracted by the extraction means to the generation model as an input/output history of the generation model to cause the generation model to refer to the input/output example.

### Supplementary Information D

The present disclosure includes the techniques described in the following supplementary notes. However, the present invention is not limited to the techniques described in the following supplementary notes, and various modifications can be made within the scope described in the claims.

### Supplementary Note D1

An information processing device including at least one processor, the at least one processor executing,
reception processing of receiving an input of target data as input data for a generation model subjected to machine learning to generate output data associated with input data,
extraction processing of extracting an input/output example associated with the target data from a plurality of input/output examples including a combination of input data and output data, and
generation control processing of causing the generation model to refer to the input/output example extracted in the extraction processing and generate output data associated with the input/output example and the target data.

The information processing device may further include a memory. The memory may store a program for causing the at least one processor to execute each of the processing.

### Supplementary Note D2

The information processing device according to supplementary note D1, in which in the extraction processing, the at least one processor extracts an input/output example associated with the target data from a database in which input/output examples are recorded.

### Supplementary Note D3

The information processing device according to supplementary note D1 or D2, in which the at least one processor further executes presentation control processing of presenting output data generated by the generation model.

### Supplementary Note D4

The information processing device according to any one of supplementary notes D1 to D3, in which
the target data includes information indicating a determination condition in a determination task for determining whether a determination target satisfies the determination condition, and
in the extraction processing, the at least one processor extracts, as the input/output example, a determination example to which a determination condition same as or similar to the determination task is applied.

### Supplementary Note D5

The information processing device according to any one of supplementary notes D1 to D4, in which
the target data includes information indicating a determination target in a determination task for determining whether the determination target satisfies a determination condition, and
in the extraction processing, the at least one processor extracts, as the input/output example, a determination example in which satisfaction of a determination condition is determined for a determination target same as or similar to the determination target.

### Supplementary Note D6

The information processing device according to any one of supplementary notes D1 to D5, in which in the generation control processing, the at least one processor inputs the input/output example extracted in the extraction processing to the generation model together with the target data to cause the generation model to refer to the input/output example.

### Supplementary Note D7

The information processing device according to any one of supplementary notes D1 to D5, in which in the generation control processing, the at least one processor inputs the input/output example extracted in the extraction processing to the generation model as an input/output history of the generation model to cause the generation model to refer to the input/output example.

### Supplementary Information E

The present disclosure includes the techniques described in the following supplementary note. However, the present invention is not limited to the techniques described in the following supplementary note, and various modifications can be made within the scope described in the claims.

### Supplementary Note E1

A non-transitory recording medium recorded with an information processing program for causing a computer to function as an information processing device, the program causing the computer to execute
reception processing of receiving an input of target data as input data for a generation model subjected to machine learning to generate output data associated with input data,
extraction processing of extracting an input/output example associated with the target data from a plurality of input/output examples including a combination of input data and output data, and
generation control processing of causing the generation model to refer to the input/output example extracted in the extraction processing and generate output data associated with the input/output example and the target data.

1. An information processing device comprising:
at least one memory storing instructions, and
at least one processor configured to execute the instructions to:
receive an input of target data as input data for a generation model subjected to machine learning to generate output data associated with input data;
extract an input/output example associated with the target data from a plurality of input/output examples including a combination of input data and output data; and
cause the generation model to refer to the input/output example extracted and generate output data associated with the input/output example and the target data.

2. The information processing device according to claim 1, wherein the at least one processor is further configured to execute the instructions to extract an input/output example associated with the target data from a database in which input/output examples are recorded.

3. The information processing device according to claim 1, wherein the at least one processor is further configured to execute the instructions to present output data generated by the generation model.

4. The information processing device according to claim 1, wherein
the target data includes information indicating a determination condition in a determination task for determining whether a determination target satisfies the determination condition; and
the at least one processor is further configured to execute the instructions to extract, as the input/output example, a determination example to which a determination condition same as or similar to the determination task is applied.

5. The information processing device according to claim 1, wherein
the target data includes information indicating a determination target in a determination task for determining whether the determination target satisfies a determination condition; and
the at least one processor is further configured to execute the instructions to extract, as the input/output example, a determination example in which satisfaction of a determination condition is determined for a determination target same as or similar to the determination target.

6. The information processing device according to claim 1, wherein the at least one processor is further configured to execute the instructions to input the input/output example extracted to the generation model together with the target data to cause the generation model to refer to the input/output example.

7. The information processing device according to claim 1, wherein the at least one processor is further configured to execute the instructions to input the input/output example extracted to the generation model as an input/output history of the generation model to cause the generation model to refer to the input/output example.

8. An information processing method implemented by at least one processor, comprising
receiving an input of target data as input data for a generation model subjected to machine learning to generate output data associated with input data;
extracting an input/output example associated with the target data from a plurality of input/output examples including a combination of input data and output data; and
causing the generation model to refer to the input/output example extracted and generate output data associated with the input/output example and the target data.

9. The information processing method according to claim 8, further comprising extracting an input/output example associated with the target data from a database in which input/output examples are recorded.

10. The information processing method according to claim 8, further comprising presenting output data generated by the generation model.

11. The information processing method according to claim 8, wherein
the target data includes information indicating a determination condition in a determination task for determining whether a determination target satisfies the determination condition; and
the method further comprising extracting, as the input/output example, a determination example to which a determination condition same as or similar to the determination task is applied.

12. The information processing method according to claim 8, wherein
the target data includes information indicating a determination target in a determination task for determining whether the determination target satisfies a determination condition; and
the method further comprising extracting, as the input/output example, a determination example in which satisfaction of a determination condition is determined for a determination target same as or similar to the determination target.

13. The information processing method according to claim 8, further comprising the at least one processor is further configured to execute the instructions to input the input/output example extracted to the generation model together with the target data to cause the generation model to refer to the input/output example.

14. The information processing method according to claim 8, further comprising inputting the input/output example extracted to the generation model as an input/output history of the generation model to cause the generation model to refer to the input/output example.

15. A non-transitory computer readable medium storing an information processing program for causing a computer to receive an input of target data as input data for a generation model subjected to machine learning to generate output data associated with input data;
extract an input/output example associated with the target data from a plurality of input/output examples including a combination of input data and output data; and
cause the generation model to refer to the input/output example extracted and generate output data associated with the input/output example and the target data.

16. The non-transitory computer readable medium according to claim 15, wherein the information processing program for causing a computer to extract an input/output example associated with the target data from a database in which input/output examples are recorded.

17. The non-transitory computer readable medium according to claim 15, wherein the information processing program for causing a computer to present output data generated by the generation model.

18. The non-transitory computer readable medium according to claim 15, wherein
the target data includes information indicating a determination condition in a determination task for determining whether a determination target satisfies the determination condition; and
wherein the information processing program for causing a computer to extract, as the input/output example, a determination example to which a determination condition same as or similar to the determination task is applied.

19. The non-transitory computer readable medium according to claim 15, wherein
the target data includes information indicating a determination target in a determination task for determining whether the determination target satisfies a determination condition; and
wherein the information processing program for causing a computer to extract, as the input/output example, a determination example in which satisfaction of a determination condition is determined for a determination target same as or similar to the determination target.

20. The non-transitory computer readable medium according to claim 15, wherein the information processing program for causing a computer to input the input/output example extracted to the generation model together with the target data to cause the generation model to refer to the input/output example.
